(19) United States
(12) Patent Application Publication
(10) Pub. No.: US 2024/0320627 A1
(43) Pub. Date: Sep. 26, 2024

(54) INFORMATION PROCESSING METHOD, APPARATUS, ELECTRONIC DEVICE, AND STORAGE MEDIUM

(71) Applicant: Beijing Zitiao Network Technology Co., Ltd., Beijing (CN)

(72) Inventor: Jiannan XIAO, Beijing (CN)

(21) Appl. No.: 18/614,336

(22) Filed: Mar. 22, 2024

(30) Foreign Application Priority Data
Mar. 22, 2023 (CN) 202310282982.7

(51) Int. Cl. G06Q 10/10

(52) U.S. Cl. CPC G06Q 10/103

(57) ABSTRACT

An information processing method and apparatus, an electronic device, and a storage medium are provided. In response to an editing operation of the first user having the first permission, a target project is created, and at least one indicator item of the target project and a data processing rule corresponding to the indicator item are determined. The indicator item includes a plurality of indicator fields. The plurality of the indicator fields include a target field. The data processing rule is used for determining a data processing result of the indicator item based on target information filled in the target field. In a second preset period, target information filled in the target field by a second user having the second permission is acquired. A data processing result of the indicator item of the second user is determined based on the target information and the data processing rule.

### CROSS-REFERENCE TO RELATED APPLICATION

The present application claims priority of the Chinese Patent Application No. 202310282982.7, filed on Mar. 22, 2023, the disclosure of which is incorporated herein by reference in its entirety as part of the present application.

### TECHNICAL FIELD

The present disclosure relates to the technical field of computers, in particular to an information processing method, an apparatus, an electronic device, and a storage medium.

### BACKGROUND

In a performance evaluating scenario, an enterprise usually evaluates the completion of multiple indicators of employees. However, the performance evaluating applications provided by relevant technologies require an evaluator to manually score the various indicators of the evaluated person in the evaluation stage. The scoring may depend on the subjective judgment of the evaluator, or may have the situation of low efficiency or miscalculation.

### SUMMARY

The content of the summary part is provided to introduce ideas in a brief form. The ideas will be described in detail in the following detailed description part. The content of the summary part is not intended to identify the key features or necessary features of the claimed technical solution, nor is it intended to limit the scope of the claimed technical solution.

According to one or more embodiments of the present disclosure, an information processing method is provided, which includes:
in the first preset period, in response to an editing operation of the first user having the first permission, creating a target project and determining at least one indicator item of the target project and a data processing rule corresponding to the indicator item; in which the indicator item includes a plurality of indicator fields, the plurality of the indicator fields include a target field, and the data processing rule is used for determining a data processing result of the indicator item based on target information filled in the target field;
in the second preset period, acquiring target information filled in the target field by the second user having the second permission; and
determining a data processing result of the indicator item of the second user based on the target information and the data processing rule.

According to one or more embodiments of the present disclosure, an information processing apparatus is provided, which includes: a project creating unit, an information acquiring unit, and a result determining unit.

The project creating unit is configured to, in the first preset period, in response to an editing operation of the first user having the first permission, create a target project and determine at least one indicator item of the target project and a data processing rule corresponding to the indicator item. The indicator item includes a plurality of indicator fields, the plurality of the indicator fields include a target field, and the data processing rule is used for determining a data processing result of the indicator item based on target information filled in the target field.

The information acquiring unit is configured to acquire target information filled in the target field by the second user having the second permission in the second preset period.

The result determining unit is configured to determine a data processing result of the indicator item for the second user based on the target information and the data processing rule.

According to one or more embodiments of the present disclosure, an electronic device is provided, which includes at least one memory and at least one processor. The at least one memory is configured to store program codes. The at least one processor is configured to invoke the program codes stored in the at least one memory to make the electronic device execute the information processing method provided by one or more embodiments of the present disclosure.

According to one or more embodiments of the present disclosure, a non-transient computer storage medium is provided. The non-transient computer storage medium stores program codes. When the program codes are executed by a computer device, the computer device is caused to execute the information processing method provided by one or more embodiments of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a flowchart of the information processing method provided according to an embodiment of the present disclosure;

FIG. 2 is a graphical user-interface provided according to an embodiment of the present disclosure;

FIG. 3 is a graphical user-interface provided according to another embodiment of the present disclosure;

FIG. 4 is a graphical user-interface provided according to another embodiment of the present disclosure;

FIG. 5 is a graphical user-interface provided according to another embodiment of the present disclosure;

FIG. 6 is a flowchart of the information processing method provided according to another embodiment of the present disclosure;

FIG. 7 is a structural schematic diagram of the information processing apparatus provided according to an embodiment of the present disclosure; and

FIG. 8 is a structural schematic diagram of the electronic device provided according to an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. The term “respond to” and related terms refer to the extent that one signal or event is affected by another, but is not affected necessarily completely or directly. If the event x occurs “in response” to the event y, then the x can respond to the y directly or indirectly. For example, the occurrence of the y may eventually lead to the occurrence of the x, but there may be other intermediate events and/or conditions. In other cases, the y may not necessarily lead to the occurrence of the x, and the x may occur even if y has not yet occurred. In addition, the term “respond to” can also mean “at least partially respond to”.

The term “determine” broadly encompasses a wide variety of actions, including acquisition, calculus, calculation, processing, derivation, investigation, lookup (e.g., looking up in a table, database, or other data structure), discovery, and similar actions, as well as receiving (e.g., receiving information), accessing (e.g., accessing data in memory), and similar actions, as well as parsing, selecting, picking, building, and similar actions. The relevant definitions of other terms are given in the following descriptions. The relevant definitions of other terms are given in the following descriptions.

It is understandable that the data involved in the technical solution (including but not limited to the data itself, the acquisition or use of the data) shall comply with the provisions of relevant laws and regulations.

It is understandable that before using the technical solutions of various embodiments of the present disclosure, the user shall be informed of the type, scope of use, and use scenarios of the personal information involved in the present disclosure through appropriate means according to the relevant laws and regulations, and the authorization of the user shall be acquired. For example, in response to receiving an active request of a user, a reminder message is sent to the user to explicitly remind the user that the operation requested by the user requires the acquisition and use of personal information of the user, so that the user can choose whether to provide the personal information to software or hardware such as an electronic device, an application program, a server or a storage medium that executes the operation of the technical solutions of the present disclosure according to the reminder message.

As an optional but non-restrictive implementation, in response to an active request of a user, the way to send a reminder message to the user, for example, may be a pop-up window. The reminder message may be presented in the form of text in the pop-up window. In addition, the pop-up window may also contain option controls for the user to choose to “agree” or “disagree” to provide the personal information to the electronic device.

It is understandable that the above-mentioned notification and the process of acquiring the authorization of the user are only illustrative and do not limit the means of implementation of the present disclosure. Other methods that satisfy the relevant laws and regulations may also be applied to the implementation of the present disclosure.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that the modifications of “one” and “more” mentioned in the present disclosure are schematic rather than restrictive, and those skilled in the art should understand that unless otherwise explicitly stated in the context, it should be understood as “one or more”.

For the purpose of the present disclosure, the phrase “A and/or B” means (A), (B) or (A and B).

The names of messages or information interacted between the plurality of apparatuses in the implementation of the present disclosure are used for illustrative purposes only, but are not used to limit the scope of these messages or information.

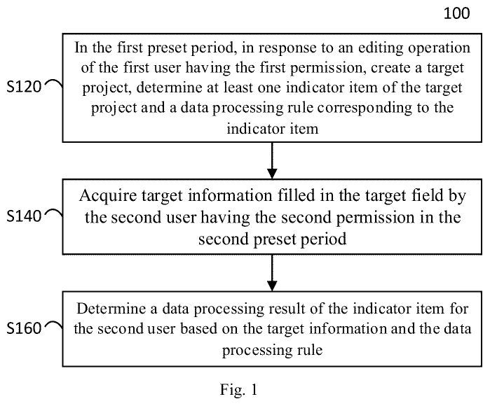

Referring to FIG. 1, FIG. 1 illustrates a flowchart of the information processing method 100 provided by an embodiment of the present disclosure, and the method 100 includes Step S120-Step S160.
Step S120: in the first preset period, in response to an editing operation of the first user having the first permission, creating a target project, determining at least one indicator item of the target project and a data processing rule corresponding to the indicator item. The indicator item includes a plurality of indicator fields, the plurality of the indicator fields include a target field, and the data processing rule is used for determining a data processing result of the indicator item based on target information filled in the target field.

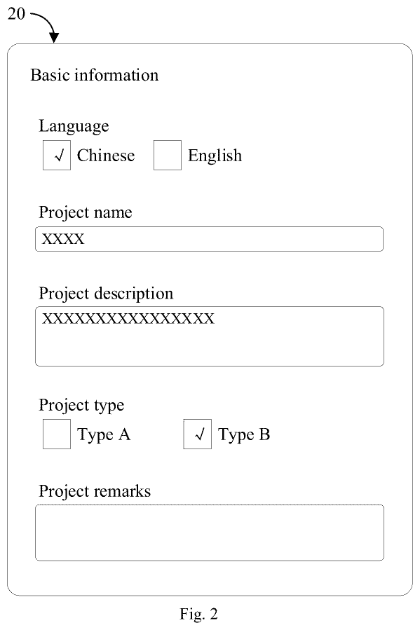

In some embodiments, referring to FIG. 2, a user may be provided with the first graphical user-interface 20 that is preset and used for creating a target project. The user can enter the information such as the name, description, type, remarks of the target project to be created on the first graphical user-interface 20.

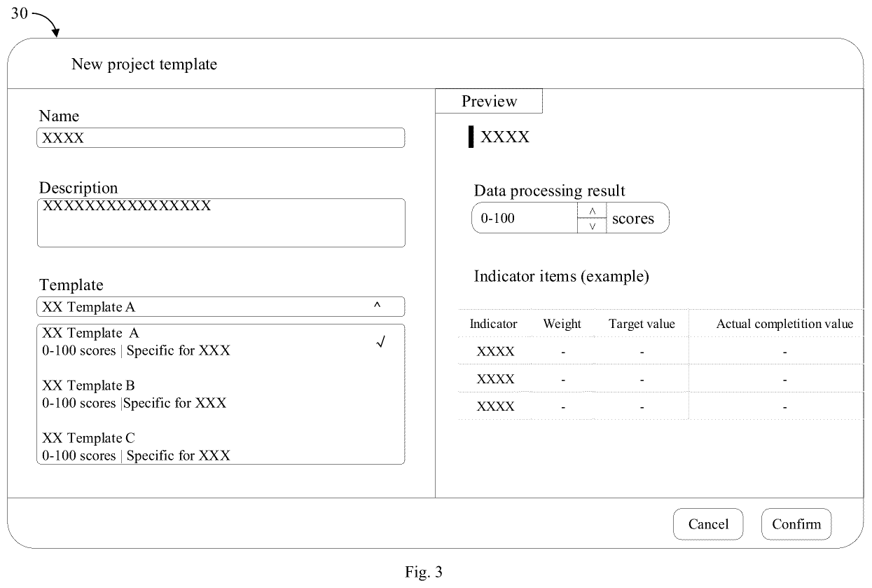

In some embodiments, referring to FIG. 3, the user may also be provided with the second graphical user-interface 30. The second graphical user-interface 30 can provide the user with a plurality of preset target project templates, including “XX template A”, “XX template B”, “XX template C”, and etc. The right part of the second graphical user-interface 30 is a preview interface, which is used for displaying the preview interface of the target project template currently selected by the user.

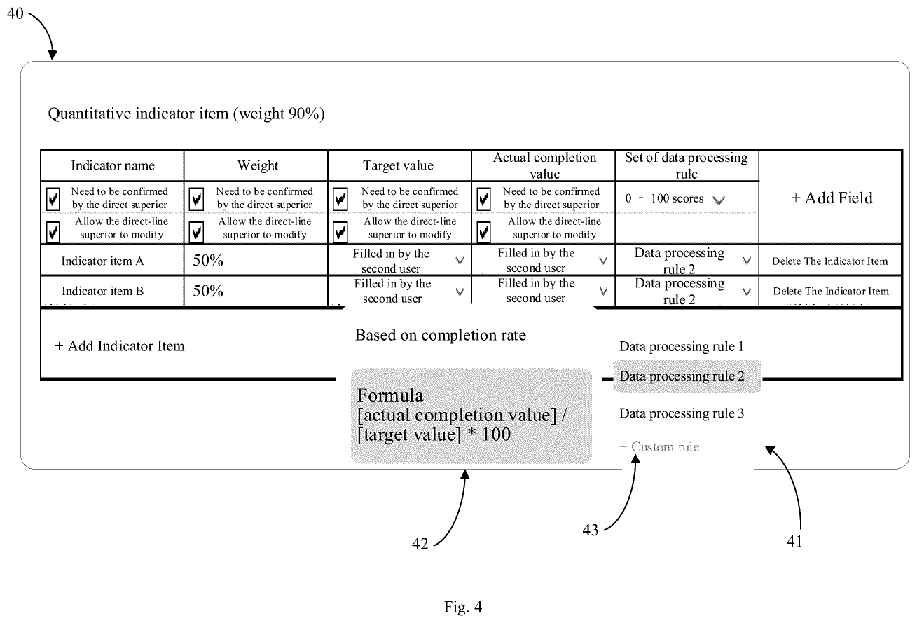

In some embodiments, referring to FIG. 4, the user may also be provided with the third graphical user-interface 40 to set one or more indicator items for the target project to be created. The user may add a new indicator item by triggering the preset control “+ Add Indicator Item”, delete the indicator item corresponding to the control by triggering the preset control “Delete Indicator Item”, or add a new indicator field for the indicator item by triggering the preset control “+ Add Field”. The indicator field includes but is not limited to the name of the indicator item, the weight of the indicator item, the unit of the indicator item, the definition of the indicator item, the target value of the indicator item, the actual completion value of the indicator item, or the data processing rule of the indicator item.

In some embodiments, the field such as the name of the indicator item, the weight of the indicator item, the unit of the indicator item, the definition of the indicator item, or the data processing rule of the indicator item may be filled in by the first user in advance. The target field such as the target value of the indicator item and the actual completion value of the indicator item may be set to be filled in by the second user.

In some embodiments, at least one preset candidate data processing rule may be displayed, and the data processing rule is determined based on the candidate data processing rule selected by the first user, or the data processing rule is determined based on the formula entered by a user in a preset formula editing interface.

For example, referring to FIG. 4, the third graphical user-interface 40 displays a drop-down menu 41 corresponding to the indicator item A set by the first user, and the drop-down menu 41 displays candidate data processing rules “data processing rule 1”, “data processing rule 2”, and “data processing rule 3”. The first user may select one of the candidate data processing rules as the data processing rule of the indicator item A. Each candidate data processing rule corresponds to a different calculation formula. For example, referring to FIG. 4, when the candidate data processing rule 2 is selected, the corresponding formula preview interface 42 can be displayed. The formula preview interface 42 displays the calculation formula corresponding to the candidate data processing rule 2, i.e., “[actual completion value]/[target value]*100”. In addition, the user may customize a data processing rule by triggering the control 43. For example, after the control 43 being triggered, a preset formula editing interface (not illustrated in FIG. 4) can be displayed for the user to enter a custom formula in the formula editing interface. In a specific embodiment, the candidate data processing rule may include determining the data processing result of the indicator item based on the ratio of the target value of the indicator item to the actual completion value.

In some embodiments, the first user having the first permission may be an administrator user, and the second user having the second permission may be a person to be evaluated, but the present disclosure is not limited to it. In the actual application scenario, the administrator user may be a person who is responsible for the administrative affairs or personnel affairs of the enterprise.
Step S140: acquiring target information filled in the target field by the second user having the second permission in the second preset period.

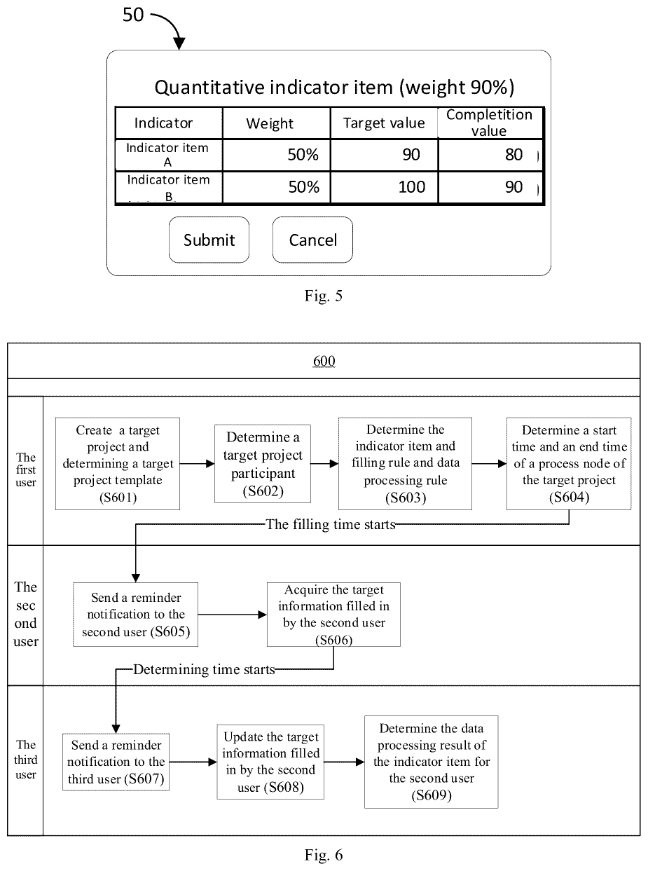

In some embodiments, referring to FIG. 5, the second user may be provided with the fourth graphical user-interface 50 that is preset and used for filling in the target information. The fourth graphical user-interface 50 may display the various indicator items to be evaluated and the indicator filed corresponding to each indicator item for the second user. The indicator field such as the name of the indicator, the weight of the indicator has been automatically filled with the content set by the first user. The second user may fill in the corresponding target information in the target field such as the target value, the actual completion value, and etc. In some embodiments, the target information includes digital information.

In some embodiments, the second user may be provided with the filling permission to fill in the target value during the preset period after the start of the second preset period corresponding to the target project. The second user may be provided with the filling permission to fill in the actual competition value during the preset period before the end of the second preset period.

In some embodiments, the second preset period may be set in advance by the first user, but the present disclosure is not limited to it.

In some embodiments, the first preset period is a preset time period for the first user to create the target project. The first user can create the target project, determine the indicator item and the data processing rule, during the first preset period. For example, the first preset period may be the period before the second preset period.
Step S160: determining a data processing result of the indicator item for the second user based on the target information and the data processing rule.

In some embodiments, the scores corresponding to various indicator items of the second user may be displayed on the graphical user-interface provided to the evaluator of the target project. In some embodiments, in the case that the second user has an indicator item whose score is not automatically generated, the score manually entered by the evaluator for the indicator item may be received.

In some embodiments, the total evaluation score of the second user in the present target project may be obtained based on weighting the scores corresponding to the various indicator items of the second user.

According to one or more than one embodiments of the present disclosure, through pre-configuring an indicator item of a target project and a data processing rule corresponding to the indicator item by the first user having the first permission, after acquiring the target information filled in a target field of the indicator item by the second user having the second permission, a system can automatically determine the data processing result corresponding to each indicator item of the second user based on the target information and the data processing rule pre-configured by the first user, so as to improve the data processing efficiency, accuracy, and objectivity of the target project.

In some embodiments, before the determining a data processing result of the indicator item of the second user based on the target information and the data processing rule, in response to an editing operation of the third user having the third permission, the target information filled in by the second user in the target field may be updated, so that the data processing result of the indicator item for the second user may be determined based on the target information after being updated and the data processing rule.

For example, after the second user fills in the target value and actual completion value of the indicator item, the third user having the third permission can modify or confirm the target value and actual completion value filled in by the second user, so that the data processing result generated based on the target value and actual completion value may be modified. In actual application scenarios, the third user having the third permission may be the superior of the second user, but the present disclosure is not limited to it.

In some embodiments, in response to the editing operation of the first user, a filling rule corresponding to the indicator field may be determined. The determining the filling rule corresponding to the indicator field includes: determining whether the content in the indicator field requires the confirmation by the user having a preset permission; and/or determining whether the content in the indicator field is allowed to be modified by the user having the preset permission.

For example, referring to FIG. 4, the third graphical user-interface 40 displays indicator fields such as “indicator name”, “weight”, “target value”, “actual completion value”, “set of data processing rule”, and the option “need to be confirmed by the direct superior” and the option “allow the direct-line superior to modify” are displayed under these indicator fields. The first user may determine whether the content under the fields needs to be confirmed or modified by a user having the preset permission for various indicator fields by selecting one or two of the preceding options.

In actual application scenarios, because the creator of the target project, i.e., the first user, may not have the ability or qualification to determine the various indicator items of the target project, and the creator may not be able to accurately set the fields of various indicator items in some scenarios. The present embodiment determines whether the content in the indicator field needs to be confirmed or modified by the user having the preset permission by determining the filling rule corresponding to the indicator field in advance, thereby setting the indicator item more flexibly and accurately.

In some embodiments, in response to the editing operation of the first user, a scope of the second user who participates in the target project and the evaluation period of the target project are determined. In the present embodiment, the first user may determine the scope of participants and the evaluation period for the target project in advance. For example, a certain year may be the evaluation cycle of the target project to evaluate the various indicators of the second user in the evaluation cycle.

In some embodiments, in response to the editing operation of the first user, the start time and the end time of a process node of the target project are determined. The process node includes: a process node for the second user to fill in the target information in the target field, or a process node for the third user having the third permission to update the target information filled in the target field by the second user. In some embodiments, a reminder notification is sent to an associated person of the process node based on the start time of the process node. For example, the first user can predetermine when the second user starts to fill in the target information and when the third user starts to confirm the target information. When the corresponding time starts, the system sends the corresponding reminder notification to the corresponding second or third user to remind the second or third user to modify or confirm the target information.

In some embodiments, the reminder notification may be sent through the instant messaging message of a preset instant messaging application, but the present disclosure is not limited to it.

Referring to FIG. 6, the information processing method 600 provided according to another embodiment of the present disclosure, includes:
Step S601: in the first preset period, in response to an editing operation of the first user with the first permission, creating a target project and determining a target project template corresponding to the target project;
step S602: in response to the editing operation of the first user, determining a scope of the second user who participates in the target project;
step S603: in response to the editing operation of the first user, determining the indicator item of the target project and the corresponding filling rule and data processing rule, in which the indicator item includes a plurality of indicator fields, the plurality of the indicator fields include a target field, and the data processing rule is used for determining a data processing result of the indicator item based on target information filled in the target field;
step S604: in response to the editing operation of the first user, determining a start time and an end time of a process node of the target project, in which the process node include: a process node for the second user to fill in the target information in the target field, or a process node for the third user having the third permission to update the target information filled in the target field by the second user;
step S605: sending a reminder notification to the second user to remind the second user to fill in the target information;
step S606: acquiring the target information filled in the target field by the second user in the second preset period;
step S607: sending a reminder notification to the third user to remind the third user to modify or confirm the target information filled in by the second user;
step S608: in response to an editing operation of the third user having the third permission, updating the target information filled in the target field by the second user;
Step S609: determining the data processing result of the indicator item for the second user based on target information after being updated and the data processing rule. In some embodiments, the data processing results corresponding to various indicator items of the second user may be displayed on the graphical user-interface provided to a user other than the third user (such as an evaluator of the target project), but the present disclosure is not limited to it.

The following takes the performance evaluation scenario as an example to illustrate the information processing method provided by the present disclosure. According to the information processing method provided by the present disclosure, the first user having the first permission (such as the person who is responsible for the administration or human resources of the enterprise) may, before evaluating the performance, create an evaluation project for performance evaluation, set the evaluation project template corresponding to the evaluation project, the scope of personnel participating in the evaluation project, the evaluation period, and the evaluation indicator, and set the filling rules and scoring rules corresponding to various evaluation indicators. The evaluation indicator may include a plurality of indicator fields. The plurality of indicator fields include a target field. The scoring rule is used for determining the score of the evaluation indicator based on the target information filled in the target field by the second user (such as the person to be evaluated). In addition, the first user may also pre-configure the start time and end time of the process node of the evaluation project, so that the system can send a reminder notification to relevant personnel based on the start time of the process node set by the first user. After the second user receiving the reminder notification, the second user may fill in the corresponding target information (such as the target value and completion value of the evaluation indicator) in the project field during the evaluation period. After the second user completes filling, the system may send a reminder notification to the third user (such as the superior of the person to be evaluated). The third user may modify or confirm the target information filled in by the second user. The system finally determines the scores corresponding to various indicators of the second user based on the target information modified and confirmed by the third user and the scoring rule pre-configured by the first user. The system may also obtain the total score of the second user in this performance evaluation through methods such as weighting based on the scores corresponding to various indicators of the second user. In the present embodiment, through the evaluation indicator of the evaluation project pre-configured by the first user and the scoring rules corresponding to the evaluation indicator, after acquiring the target information filled in the target field of the evaluation indicator by the second user, the performance evaluation system can automatically determine the scores corresponding to various evaluation indicators of the second user based on the target information and the scoring rules pre-configured by the first user, thereby improving the scoring efficiency, accuracy and objectivity of the performance evaluation, and solving the problem that the artificial scoring in the performance evaluation has the strong subjectivity and low efficiency, and is prone to miscalculation.

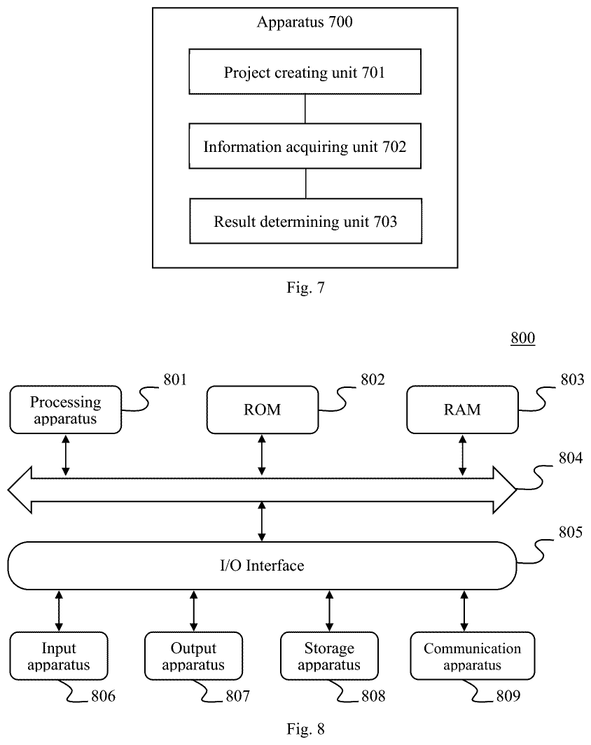

Correspondingly, referring to FIG. 7, an information processing apparatus 700 provided according to an embodiment of the present disclosure, includes a project creating unit 701, an information acquiring unit 702, and a result determining unit 703.

The project creating unit 701 is configured to, in the first preset period, in response to an editing operation of the first user having the first permission, create a target project, and determine at least one indicator item of the target project and a data processing rule corresponding to the indicator item. The indicator item includes a plurality of indicator fields, the plurality of the indicator fields include a target field, and the data processing rule is used for determining a data processing result of the indicator item based on target information filled in the target field.

The information acquiring unit 702 is configured to acquire target information filled in the target field by the second user having the second permission in the second preset period.

The result determining unit 703 is configured to determine a data processing result of the indicator item for the second user based on the target information and the data processing rule.

According to one or more embodiments of the present disclosure, the project creating unit is configured to display at least one preset candidate data processing rule, and determine the data processing rule based on a candidate data processing rule selected by the first user, or determine the data processing rule based on a formula entered by a user in a preset formula editing interface.

According to one or more embodiments of the present disclosure, the information processing apparatus further includes an information updating unit.

The information updating unit is configured to update the target information filled in the target field by the second user in response to an editing operation of the third user having the third permission.

The result determining unit is configured to determine the data processing result of the indicator item for the second user based on target information after being updated and the data processing rule.

According to one or more embodiments of the present disclosure, the target field includes a target value and an actual completion value corresponding to the indicator item.

According to one or more embodiments of the present disclosure, the information processing apparatus further includes a filling rule determining unit.

The filling rule determining unit is configured to determine a filling rule corresponding to the indicator field in response to the editing operation of the first user. The determining a filling rule corresponding to the indicator field, includes: determining whether a content in the indicator field requires a confirmation by a user having a preset permission; and/or determining whether the content in the indicator field is allowed to be modified by the user having the preset permission.

According to one or more embodiments of the present disclosure, the information processing apparatus further includes a user scope determining unit.

The user scope determining unit is configured to determine a scope of the second user who participates in the target project in response to the editing operation of the first user.

According to one or more embodiments of the present disclosure, the information processing apparatus further includes a process node determining unit.

The process node determining unit is configured to determine the start time and end time of a process node of the target project in response to the editing operation of the first user. The process node includes: a process node for the second user to fill in the target information in the target field, or a process node for the third user having the third permission to update the target information filled in the target field by the second user.

According to one or more embodiments of the present disclosure, the information processing apparatus further includes a reminder notification unit.

The reminder notification unit is configured to send a reminder notification to an associated person of the process node based on the start time of the process node.

For the embodiments of the apparatus, because the apparatus embodiments basically correspond to the method embodiments, the relevant places can be referred to the part description of the method embodiments. The apparatus embodiments described above are only schematic, the modules described as detached modules may or may not be separated. Some or all of the modules can be selected according to actual needs to implement the purpose of the present embodiment. A person skilled in the art can understand and implement it without creative effort.

Correspondingly, according to one or more than one embodiments of the present disclosure, an electronic device is provided, which includes at least one memory and at least one processor. The at least one memory is configured to store program codes, and the at least one processor is configured to invoke the program codes stored in the at least one memory to make the electronic device execute the information processing method provided according to one or more embodiments of the present disclosure.

Correspondingly, according to one or more than one embodiments of the present disclosure, a non-transient computer storage medium is provided. The non-transient computer storage medium stores program codes. The program codes can be executed by a computer device to make the computer device to execute the information processing method provided according to one or more embodiments of the present disclosure.

Referring to FIG. 8, FIG. 8 illustrates a schematic structural diagram of an electronic device 800 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 8 is merely an example, and should not pose any limitation to the functions and the scope of use of the embodiments of the present disclosure.

As illustrated in FIG. 8, the electronic device 800 may include a processing apparatus 801 (e.g., a central processing unit, a graphics processing unit, etc.), which can perform various suitable actions and processing according to a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are interconnected by means of a bus 804. An input/output (I/O) interface 805 is also connected to the bus 804.

Usually, the following apparatus may be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a loudspeaker, a vibrator, or the like; a storage apparatus 808 including, for example, a magnetic tape, a hard disk, or the like; and a communication apparatus 809. The communication apparatus 809 may allow the electronic device 800 to be in wireless or wired communication with other devices to exchange data. While FIG. 8 illustrates the electronic device 800 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 809 and installed, or may be installed from the storage apparatus 808, or may be installed from the ROM 802. When the computer program is executed by the processing apparatus 801, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to execute the above method of the present disclosure.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, an information processing method is provided. The information processing method includes: in the first preset period, in response to an editing operation of the first user having the first permission, creating a target project, determining at least one indicator item of the target project and a data processing rule corresponding to the indicator item, in which the indicator item includes a plurality of indicator fields, the plurality of the indicator fields include a target field, and the data processing rule is used for determining a data processing result of the indicator item based on target information filled in the target field; in the second preset period, acquiring target information filled in the target field for the second user having a second permission; and determining a data processing result of the indicator item for the second user based on the target information and the data processing rule.

According to one or more embodiments of the present disclosure, the determining a data processing rule corresponding to the indicator item, includes: displaying at least one preset candidate data processing rule, and determining the data processing rule based on a candidate data processing rule selected by the first user; or determining the data processing rule based on a formula entered by a user in a preset formula editing interface.

According to one or more than one embodiments of the present disclosure, before the determining a data processing result of the indicator item for the second user based on the target information and the data processing rule, the information processing method further includes: in response to an editing operation of the third user having the third permission, updating the target information filled in the target field by the second user. The determining a data processing result of the indicator item for the second user based on the target information and the data processing rule, includes: determining the data processing result of the indicator item for the second user based on target information after being updated and the data processing rule.

According to one or more than one embodiments of the present disclosure, the target field includes a target value and an actual completion value corresponding to the indicator item.

The information processing method provided according to one or more than one embodiments of the present disclosure, further includes: in response to the editing operation of the first user, determining a filling rule corresponding to the indicator field. The determining a filling rule corresponding to the indicator field, includes: determining whether a content in the indicator field requires a confirmation by a user with a preset permission; and/or determining whether the content in the indicator field is allowed to be modified by the user having the preset permission.

The information processing method provided according to one or more than one embodiments of the present disclosure, further includes: in response to the editing operation of the first user, determining a scope of the second user who participates in the target project.

The information processing method provided according to one or more than one embodiments of the present disclosure, further includes: in response to the editing operation of the first user, determining a start time and an end time of a process node of the target project. The process node includes: a process node for the second user to fill in the target information in the target field, or a process node for the third user having the third permission to update the target information filled in the target field by the second user.

The information processing method provided according to one or more than one embodiments of the present disclosure, further includes: sending a reminder notification to an associated person of the process node based on the start time of the process node.

According to one or more than one embodiments of the present disclosure, an information processing apparatus is provided. The information processing apparatus includes a project creating unit, an information acquiring unit, and a result determining unit. The project creating unit is configured to, in the first preset period, in response to an editing operation of the first user with the first permission, create a target project and determine at least one indicator item of the target project and a data processing rule corresponding to the indicator item. The indicator item includes a plurality of indicator fields, the plurality of the indicator fields include a target field, and the data processing rule is used for determining a data processing result of the indicator item based on target information filled in the target field. The information acquiring unit is configured to acquire target information filled in the target field by the second user in the second preset period. The result determining unit is configured to determine a data processing result of the indicator item for the second user based on the target information and the data processing rule.

According to one or more than one embodiments of the present disclosure, an electronic device is provided. The electronic device includes at least one memory and at least one processor. The at least one memory is configured to store program codes, and the at least one processor is configured to invoke the program codes stored in the at least one memory to make the electronic device execute the information processing method provided by one or more than one embodiments of the present disclosure.

According to one or more than one embodiments of the present disclosure, a non-transient computer storage medium is provided. The non-transient computer storage medium stores program codes, and when the program codes are executed by a computer device, the computer device is caused to execute the information processing method provided by one or more than one embodiments of the present disclosure.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An information processing method, comprising:
in a first preset period, in response to an editing operation of a first user having a first permission, creating a target project and determining at least one indicator item of the target project and a data processing rule corresponding to the indicator item; wherein the indicator item comprises a plurality of indicator fields, the plurality of the indicator fields comprise a target field, and the data processing rule is used for determining a data processing result of the indicator item based on target information filled in the target field;
in a second preset period, acquiring target information filled in the target field by a second user having a second permission; and
determining a data processing result of the indicator item for the second user based on the target information and the data processing rule.

2. The method of claim 1, wherein the determining a data processing rule corresponding to the indicator item, comprises:
displaying at least one preset candidate data processing rule, and determining the data processing rule based on a candidate data processing rule selected by the first user; or
determining the data processing rule based on a formula entered by a user in a preset formula editing interface.

3. The method of claim 1, wherein, before the determining a data processing result of the indicator item for the second user based on the target information and the data processing rule, the information processing method further comprises:
in response to an editing operation of a third user having a third permission, updating the target information filled in the target field by the second user; and
the determining a data processing result of the indicator item for the second user based on the target information and the data processing rule, comprises: determining the data processing result of the indicator item for the second user based on target information after being updated and the data processing rule.

4. The method of claim 1, wherein the target field comprises a target value and an actual completion value corresponding to the indicator item.

5. The method of claim 1, further comprising:
in response to the editing operation of the first user, determining a filling rule corresponding to the indicator field;
wherein the determining a filling rule corresponding to the indicator field, comprises:
determining whether a content in the indicator field requires a confirmation by a user having a preset permission; and/or determining whether the content in the indicator field is allowed to be modified by the user having the preset permission.

6. The method of claim 1, further comprising:
in response to the editing operation of the first user, determining a scope of the second user who participates in the target project.

7. The method of claim 1, further comprising:
in response to the editing operation of the first user, determining a start time and an end time of a process node of the target project;
wherein the process node comprises: a process node for the second user to fill in the target information in the target field, or a process node for a third user having a third permission to update the target information filled in the target field by the second user.

8. The method of claim 7, further comprising:
sending a reminder notification to an associated person of the process node based on the start time of the process node.

9. An information processing apparatus, comprising:
a project creating unit, configured to, in a first preset period, in response to an editing operation of a first user having a first permission, create a target project and determine at least one indicator item of the target project and a data processing rule corresponding to the indicator item; wherein the indicator item comprises a plurality of indicator fields, the plurality of the indicator fields comprise a target field, and the data processing rule is used for determining a data processing result of the indicator item based on target information filled in the target field;
an information acquiring unit, configured to acquire target information filled in the target field by a second user having a second permission, in a second preset period; and
a result determining unit, configured to determine a data processing result of the indicator item for the second user based on the target information and the data processing rule.

10. The apparatus of claim 9, wherein the project creating unit is configured to display at least one preset candidate data processing rule, and determine the data processing rule based on a candidate data processing rule selected by the first user, or
determine the data processing rule based on a formula entered by a user in a preset formula editing interface.

11. The apparatus of claim 9, further comprising:
an information updating unit, configured to update the target information filled in the target field by the second user, in response to an editing operation of a third user having a third permission, and
wherein the result determining unit is configured to determine the data processing result of the indicator item for the second user based on target information after being updated and the data processing rule.

12. The apparatus of claim 9, wherein the target field comprises a target value and an actual completion value corresponding to the indicator item.

13. The apparatus of claim 9, further comprising:
a filling rule determining unit, configured to determine a filling rule corresponding to the indicator field in response to the editing operation of the first user,
wherein the determining a filling rule corresponding to the indicator field, comprises:
determining whether a content in the indicator field requires a confirmation by a user having a preset permission; and/or
determining whether the content in the indicator field is allowed to be modified by the user having the preset permission.

14. The apparatus of claim 9, further comprising:
a user scope determining unit, configured to determine a scope of the second user who participates in the target project in response to the editing operation of the first user.

15. The apparatus of claim 9, further comprising:
a process node determining unit, configured to determine a start time and an end time of a process node of the target project in response to the editing operation of the first user, wherein the process node comprises: a process node for the second user to fill in the target information in the target field, or a process node for a third user having a third permission to update the target information filled in the target field by the second user.

16. The apparatus of claim 15, further comprising:
a reminder notification unit, configured to send a reminder notification to an associated person of the process node based on the start time of the process node.

17. An electronic device, comprising:
at least one memory and at least one processor;
wherein the at least one memory is configured to store program codes, and the at least one processor is configured to invoke the program codes stored in the at least one memory to make the electronic device to:
in a first preset period, in response to an editing operation of a first user having a first permission, create a target project and determine at least one indicator item of the target project and a data processing rule corresponding to the indicator item; wherein the indicator item comprises a plurality of indicator fields, the plurality of the indicator fields comprise a target field, and the data processing rule is used for determining a data processing result of the indicator item based on target information filled in the target field;
in a second preset period, acquire target information filled in the target field by a second user having a second permission; and
determine a data processing result of the indicator item for the second user based on the target information and the data processing rule.

18. The electronic device of claim 17, wherein the determining a data processing rule corresponding to the indicator item, comprises:
displaying at least one preset candidate data processing rule, and determining the data processing rule based on a candidate data processing rule selected by the first user; or determining the data processing rule based on a formula entered by a user in a preset formula editing interface.

19. The electronic device of claim 17, wherein the program codes further makes the electronic device to:
in response to an editing operation of a third user having a third permission, update the target information filled in the target field by the second user; and
the determining a data processing result of the indicator item for the second user based on the target information and the data processing rule, comprises: determining the data processing result of the indicator item for the second user based on target information after being updated and the data processing rule.

20. A non-transient computer storage medium, wherein,
the non-transient computer storage medium stores program codes, and when the program codes are executed by a computer device, the computer device is caused to execute the method of claim 1.
